(19) United States
(12) Patent Application Publication
(10) Pub. No.: US 2024/0297457 A1
(43) Pub. Date: Sep. 5, 2024

(54) TWO WIRE ELECTRICAL CONNECTOR

(71) Applicant: Sentinel Connector Systems, Inc., York, PA (US)

(72) Inventors: Robert Brennan, York, PA (US); Randy Schwartz, York, PA (US); Gavin Fowler, York, PA (US)

(73) Assignee: Sentinel Connector Systems, Inc., York, PA (US)

(21) Appl. No.: 18/594,204

(22) Filed: Mar. 4, 2024

Related U.S. Application Data
(60) Provisional application No. 63/449,459, filed on Mar. 2, 2023.

(51) Int. Cl. H01R 13/50; H01R 13/516; H01R 24/28

(52) U.S. Cl. CPC H01R 13/501; H01R 13/516; H01R 24/28

(57) ABSTRACT

A modular plug system including a housing including an opening extending from a back end of the plug to an opposing front wall, a plurality of slots in a top surface that extend into the cavity, a first opening adjacent to a second opening, a third opening adjacent to a fourth opening, a partition separating the first opening and second opening from the third opening and fourth opening, where at least two slots include a conductive material.

### CROSS REFERENCE TO PRIOR APPLICATIONS

This application claims the benefit of U.S. Provisional Application No. 63/449,459 filed on Mar. 2, 2023, titled “Two Wire Electrical Connector” the contents of which are hereby incorporated by reference.

### BACKGROUND OF THE PRESENT INVENTION

As more historically analog devices transition to digital connections, the wiring requirements and power requirements of these devices are designed more for analog devices. However, the infrastructure these devices reside on is gear toward traditional data networks. Modular connectors and patch panels are not suited for connections to historically analog devices. Historically, power and data transmitted on large conductor cable were terminated separately on different connectors. This has led to a large industry of custom connectors that increases the overall cost of wiring projects.

A need exists connector that can accommodate cables having different wire diameters.

### SUMMARY OF THE PRESENT INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a modular plug system including a housing including an opening extending from a back end of the plug to an opposing front wall, a plurality of slots in a top surface that extend into the cavity, a first opening adjacent to a second opening, a third opening adjacent to a fourth opening, a partition separating the first opening and second opening from the third opening and fourth opening, where at least two slots include a conductive material.

In another embodiment, the first opening and second opening are the same size.

In another embodiment, the third opening and fourth opening are the same size.

In another embodiment, the first opening and second opening are smaller in diameter than the third opening and fourth opening.

In another embodiment, each of the plurality of slots is positioned above one of the first opening, second opening, third opening or fourth opening.

In another embodiment, the first opening second opening are each sized to accept a data wire.

In another embodiment, the third opening and second opening are each sized to accept a power wire.

In another embodiment, the first opening, second opening, third opening and fourth opening extend through the front wall of the plug to allow a wire in each opening to extend beyond the font wall of the plug.

In another embodiment, the third opening and fourth opening are sized to accommodate an 18 gauge wire or larger.

In another embodiment, the first opening and second opening are sized to accommodate a 22 gauge wire.

Another embodiment of the present disclosure includes a method of forming a modular plug system including the steps of forming a housing including an opening extending from a back end of the plug to an opposing front wall, forming a plurality of slots in a top surface that extend into the cavity, forming a first opening adjacent to a second opening, forming a third opening adjacent to a fourth opening, forming a partition separating the first opening and second opening from the third opening and fourth opening, where at least two slots include a conductive material.

In another embodiment, the first opening and second opening are the same size.

In another embodiment, the third opening and fourth opening are the same size.

In another embodiment, the first opening and second opening are smaller in diameter than the third opening and fourth opening.

In another embodiment, each of the plurality of slots is positioned above one of the first opening, second opening, third opening or fourth opening.

In another embodiment, the first opening second opening are each sized to accept a data wire.

In another embodiment, the third opening and second opening are each sized to accept a power wire.

In another embodiment, the first opening, second opening, third opening and fourth opening extend through the front wall of the plug to allow a wire in each opening to extend beyond the font wall of the plug.

In another embodiment, the third opening and fourth opening are sized to accommodate an 18 gauge wire or larger.

In another embodiment, the first opening and second opening are sized to accommodate a 22 gauge wire.

### DRAWING SUMMARY

FIG. 1 depicts a perspective view of the plug;

FIG. 2 depicts a rear view of the plug;

FIG. 3 depicts a front view of the plug.

FIG. 4 depicts a top perspective view of the plug;

FIG. 5 depicts a top perspective view of the plug engaging a cable;

FIG. 6 depicts a top perspective view of the plug engaging a cable; and

FIG. 7 depicts a front view cut way view of the plug.

### DETAILED DESCRIPTION

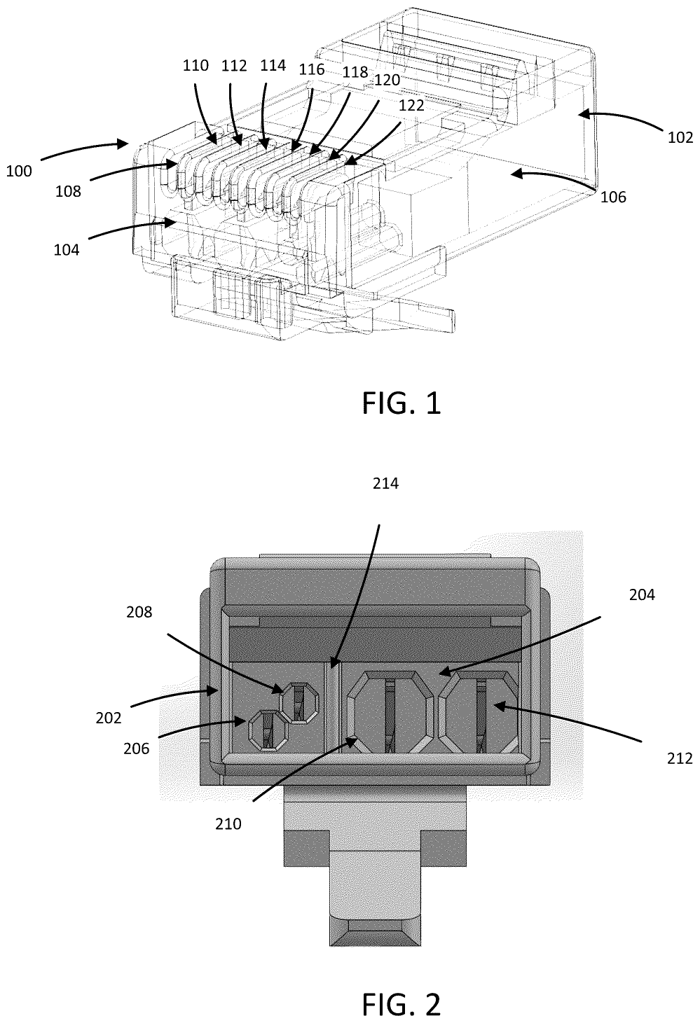

FIG. 1 depicts a front view of a plug 100. An opening 102 on one end of the plug that extends to the front surface 104 on an opposite side of the plug 102 to form a channel. In one embodiment, the opening 102 is sized to accommodate a load bar 106. The channel includes guides on the top surface and a bottom surface of the channel. The guides are positioned to engage with wires inserted into the channel such that the wires are maneuvered into a predetermined position in the channel. A front portion 106 of the plug includes slots 108, 110, 112, 114, 116, 118, 120 and 122.

FIG. 2 depicts a rear view of the plug 100. Two sets of openings 202 and 204 are shown. The first set openings 202 includes a first opening 206 and a second opening 208. The second set of openings 204 includes a first opening 208 and a second opening 210. In one embodiment, a partition 214 separates the first set of openings 202 and the second set of openings. The partition 214 extends between the two sets of openings 202 and 204 to engage the front surface 104 of the plug 100.

In one embodiment, the first set of openings 202 have a smaller diameter than the second set of openings 204. Each opening 206, 208, 210 and 212 is positioned such that the center point of the each opening 206, 208, 210 and 212 is aligned with a corresponding slot 108, 110, 112, 114, 116, 118, 120 and 122. Each slot 108, 110, 112, 114, 116, 118, 120 and 122 includes a pin that is sized to extend through the slot 108, 110, 112, 114, 116, 118, 120 and 122 and a wire positioned below the slot 108, 110, 112, 114, 116, 118, 120 and 122.

The openings 206, 208, 210 and 212 are sized to engage wires in one or more cables. The cable sizes may be any size from 24 gauge to 12 gauge wire. In one embodiment, the lower sized openings engage data communications wires, and the larger openings engage wires carrying power. In another embodiment, the power cable transmits fifty watts of power. The thickness of the partition 214 is determined based on the amount of power carried over the larger conductors with the thickness increasing the large the power carried over the wires.

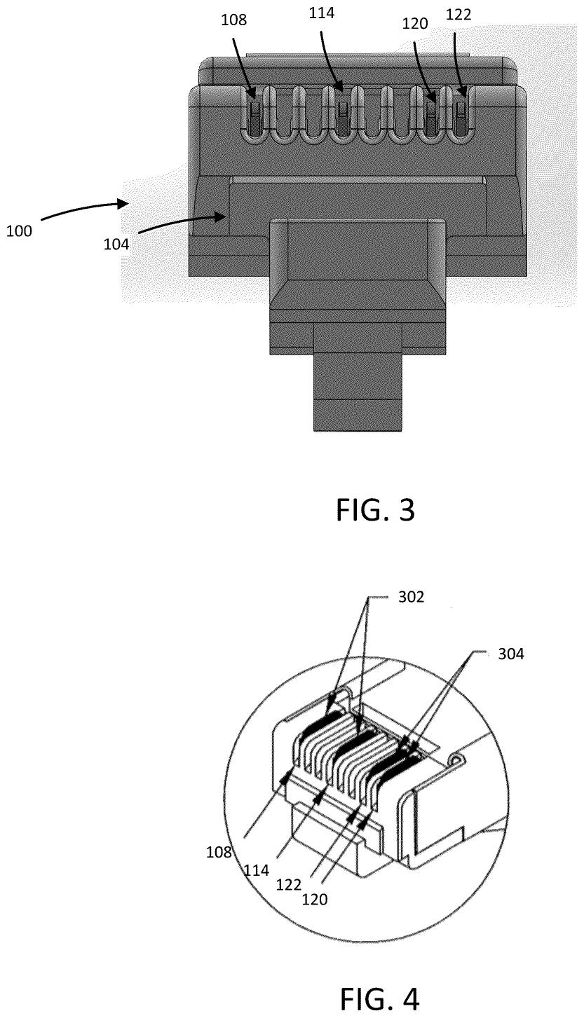

FIG. 3 depicts a front view cut away view of the plug 100. The front surface 104 of the plug is closed. Pins are positioned in slots 108, 114, 120 and 122. The pins are placed in slots that concentrically align with the openings 202 and 204. Slots 104 and 108 correspond to the large openings 204 and slots 120 and 122 correspond to the smaller openings 202. In one embodiment, slots 104 and 108 include pins made of phos bronze and having a thickness of 0.014 in, and slots 120 and 122 include pins made of phos bronze and have a thickness of 0.012 in. The position of the pins in different slots is adjusted based on the gauge of the wire engaging the openings 202 and 204. The number of openings is only limited by the amount of space available on the front surface of the plug. Openings 202 and 204 may include more than two openings each. In one embodiment, multiple partitions 214 may be formed between openings.

The openings 202 and 204 may extend through the front surface 104 of the plug 100. Once the wires extend through the front surface 104 of the plug, a crimping tool with a cutting edge or a sharp tool is used to cut the wires such that the length of the wires is such that the wires no longer extend beyond the front surface 104. A cap or cover is placed over the cut wires on the front surface to cover the ends of the wires. In one embodiment, the cap or cover includes partitions between the wires to prevent electrical arching from wire end to wire end. In another embodiment, partitions 214 are formed in plug 100 between each wire to prevent arcing.

FIG. 4 depicts a top perspective view of a plug 100. The plug includes power connections 302 and data connections 304. The power connections 302 include a first slot 108 and second slot 114 that include a metal unit that engages a wire passing under the corresponding slot 108 and/or 114. The data connections 304 include a first slot 122 and a second slot 124. The two slots 108 and 114 in the power connection 302 are separated by at least two slots 110 and 112. By providing spacing in the form of two empty slots, larger gauge wire can be inserted into the plug 100. In one embodiment, the cable is an 18 gauge cable. In another embodiment, the cable is a 22 gauge cable. The data connection 304 may be separated by any empty slots, which allows the data cables to be positioned away from the power connection preventing the power connection 302 from interfering with the data connection 304. In one embodiment, spacers are positioned inside the plug cavity to separate the power connection 302 from the data connection 304.

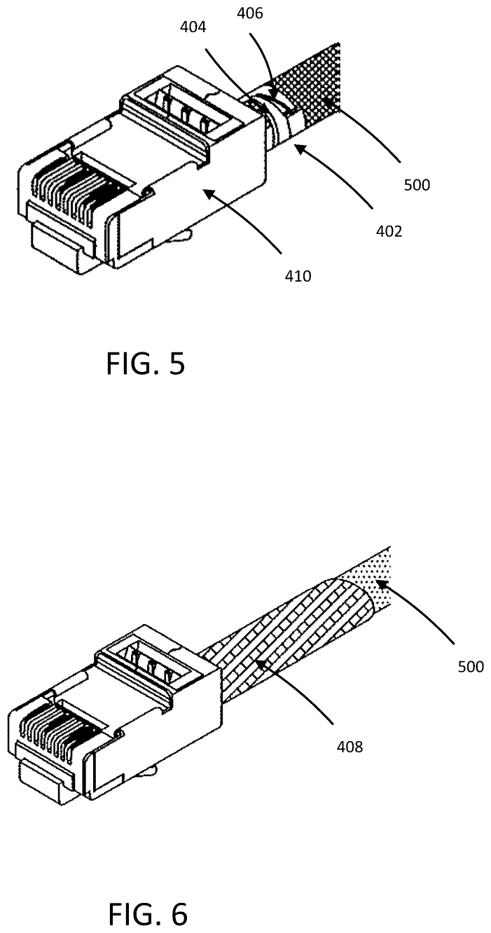

FIG. 5 depicts a top perspective view of a plug 100 engaging a wire 500. A braid unit 402 extending from a back side of the plug 100 near the opening 102 to the cavity wraps around the wire 500. In one embodiment, the braid unit 402 is connected to a metal case 410 that surrounds the plug and creates a shielding effect in the wire 500. The braid unit 402 includes two extensions 404 and 406 that are wrapped around the wire 500 such that the extensions 404 and 406 are in electrical communication with the shielding portion of the wire 500. FIG. 6 depicts a plastic seal 408 adhered to the wire 500 covering the braid unit 402.

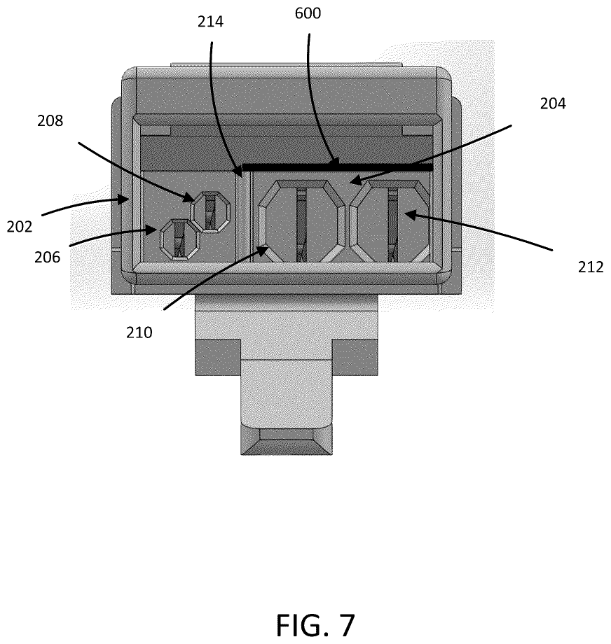

FIG. 7 depicts a front view cut away view of the plug 100. The plug includes the metal case 410 that surrounds the plug 100. The partition 214 is made from the same material as the metal case 410 and a wire 600 connects the partition 214 to the metal case 410. The wire 600 is made from the same material as the metal case 410 and the partition 214 and provides electrical connectivity between the partition 214 and the metal case 410.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A modular plug system including:
a housing including an opening extending from a back end of the plug to an opposing front wall;
a plurality of slots in a top surface that extend into the cavity;
a first opening adjacent to a second opening;
a third opening adjacent to a fourth opening;
a partition separating the first opening and second opening from the third opening and fourth opening,
wherein at least two slots include a conductive material.

2. The modular plug of claim 1 wherein the first opening and second opening are the same size.

3. The modular plug of claim 2 wherein the third opening and fourth opening are the same size.

4. The modular plug of claim 3 wherein the first opening and second opening are smaller in diameter than the third opening and fourth opening.

5. The modular plug of claim 1 wherein each of the plurality of slots is positioned above one of the first opening, second opening, third opening or fourth opening.

6. The modular plug of claim 1 wherein the first opening second opening are each sized to accept a data wire.

7. The modular plug of claim 1 wherein the third opening and second opening are each sized to accept a power wire.

8. The modular plug of claim 1 wherein the first opening, second opening, third opening and fourth opening extend through the front wall of the plug to allow a wire in each opening to extend beyond the font wall of the plug.

9. The modular plug of claim 1 wherein the third opening and fourth opening are sized to accommodate an 18 gauge wire or larger.

10. The modular plug of claim 1 wherein the first opening and second opening are sized to accommodate a 22 gauge wire.

11. A method of forming a modular plug system including the steps of:
forming a housing including an opening extending from a back end of the plug to an opposing front wall;
forming a plurality of slots in a top surface that extend into the cavity;
forming a first opening adjacent to a second opening;
forming a third opening adjacent to a fourth opening;
forming a partition separating the first opening and second opening from the third opening and fourth opening,
wherein at least two slots include a conductive material.

12. The method of claim 11 wherein the first opening and second opening are the same size.

13. The method of claim 12 wherein the third opening and fourth opening are the same size.

14. The method of claim 13 wherein the first opening and second opening are smaller in diameter than the third opening and fourth opening.

15. The method of claim 11 wherein each of the plurality of slots is positioned above one of the first opening, second opening, third opening or fourth opening.

16. The method of claim 11 wherein the first opening second opening are each sized to accept a data wire.

17. The method of claim 11 wherein the third opening and second opening are each sized to accept a power wire.

18. The method of claim 11 wherein the first opening, second opening, third opening and fourth opening extend through the front wall of the plug to allow a wire in each opening to extend beyond the font wall of the plug.

19. The method of claim 11 wherein the third opening and fourth opening are sized to accommodate an 18 gauge wire or larger.

20. The method of claim 11 wherein the first opening and second opening are sized to accommodate a 22 gauge wire.
